(19) United States
(12) Patent Application Publication
(10) Pub. No.: US 2010/0030874 A1
(43) Pub. Date: Feb. 4, 2010

(54) SYSTEM AND METHOD FOR SECURE STATE NOTIFICATION FOR NETWORKED DEVICES

(76) Inventors: Louis ORMOND, Irvine, CA (US); Amir SHAHINDOUST, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/184,310

(22) Filed: Aug. 1, 2008

(51) Int. Cl. G06F 15/177

(52) U.S. Cl. 709/220

(57) ABSTRACT

The subject application is directed to a secure state notification system and method for networked devices. Security settings associated with networked devices are each self tested by the corresponding networked device. Report data is then generated by each of the networked devices from the output of the self testing. A network message is then generated by each of the networked devices via an associated network interface in accordance with the generated report data. A network message is then received from each networked device into an associated administrative device, and a display is generated on the administrative device corresponding to the report data in accordance with each received network message.

### BACKGROUND OF THE INVENTION

The subject application is directed generally to maintaining security in networked document processing devices. The application is particularly suited for maintaining security for networked document processing devices by periodically running test routines on each device and reporting results to an administrator.

Information processing is tightly integrated with work being completed in offices and factories. Powerful devices interact with one another via exchange of data in networked environments. Devices include conventional, general purpose computers, such as workstations, but have grown to include embedded processing capability.

Document processing devices include printers, copiers, scanners and facsimile devices. Today, a device frequently has more than one of these functions, and is often referred to as a multifunction peripheral (MFP). Document processing devices, particularly MFPs, frequently include components associated with general purpose computers, such as workstations, and include processors, random access memory, non-volatile storage, and a network connection. In many such devices, a computer function is found on what is referred to as a controller. A controller serves to perform many monitoring, maintenance, and operational functions of a device, and typically includes software which allows users to access powerful functions available in such devices via an easily understood interface.

Networked, information processing devices, including document processing devices, are subject to security risk by being accessed either from within an associated network, or via connection to a larger network, such as the Internet. Various hardware and software elements of a device can leave it open and vulnerable for unauthorized access. Such unauthorized access may give an intruder access to sensitive information or control of a device.

Vulnerability of a networked device can be based on hardware, software, or a combination of both. Software concerns include exploitable vulnerabilities in existing software, such as software that has not been updated, settings such as open ports, or settings which allow for an intruder to modify, install or run unauthorized code.

There is a substantial burden associated with assuring that many devices are each secure relative to possible vulnerabilities.

### SUMMARY OF THE INVENTION

In accordance with one embodiment of the subject application, there is provided a system and method for maintaining security in networked document processing devices.

Further, in accordance with one embodiment of the subject application, there is provided a system and method for maintaining security for networked document processing devices by periodically running test routines on each device and reporting results to an administrator.

Still further in accordance with one embodiment of the subject application, there is provided a system for secure state notification of networked devices. The system includes a plurality of networked devices. Each networked device includes a processor, a data storage, and a network interface. Each networked device also includes testing means adapted for self testing each of a plurality of security settings associated therewith, means adapted for generating report data in accordance with an output of the testing means, and means adapted for generating a network message in accordance with generated report data via the network interface. The system also includes means adapted for receiving a network message from each networked device into an associated administrative device and means adapted for generating a display on the associated administrative device corresponding to report data in accordance with each received network message.

Still further, in accordance with one embodiment of the subject application, there is provided a method for secure state notification of networked devices. Each of a plurality of security settings associated with each of a plurality of networked devices is self tested, wherein each networked device tests each security setting associated therewith. Report data is generated, by each of the networked devices, in accordance with an output of the self testing step and a network message is generated by each of the networked devices via a network interface associated with each networked device, in accordance with generated report data and is received into an associated administrative device. A display is generated on the associated administrative device corresponding to report data in accordance with each received network message.

Still other advantages, aspects and features of the subject application will become readily apparent to those skilled in the art from the following description wherein there is shown and described a preferred embodiment of the subject application, simply by way of illustration of one of the modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a secure state notification system for networked devices according to one embodiment of the subject application;

FIG. 2 is a block diagram illustrating device hardware for use in the secure state notification system for networked devices according to one embodiment of the subject application;

FIG. 3 is a functional diagram illustrating the device for use in the secure state notification system for networked devices according to one embodiment of the subject application;

FIG. 4 is a block diagram illustrating controller hardware for use in the secure state notification system for networked devices according to one embodiment of the subject application;

FIG. 5 is a functional diagram illustrating the controller for use in the secure state notification system for networked devices according to one embodiment of the subject application;

FIG. 6 is a functional diagram illustrating a user device for use in the secure state notification system for networked devices according to one embodiment of the subject application;

FIG. 7 is a flowchart illustrating a secure state notification method for networked devices according to one embodiment of the subject application; and

FIG. 8 is a flowchart illustrating a secure state notification method for networked devices according to one embodiment of the subject application.

### DETAILED DESCRIPTION OF THE PREFERRED EMBODIMENT

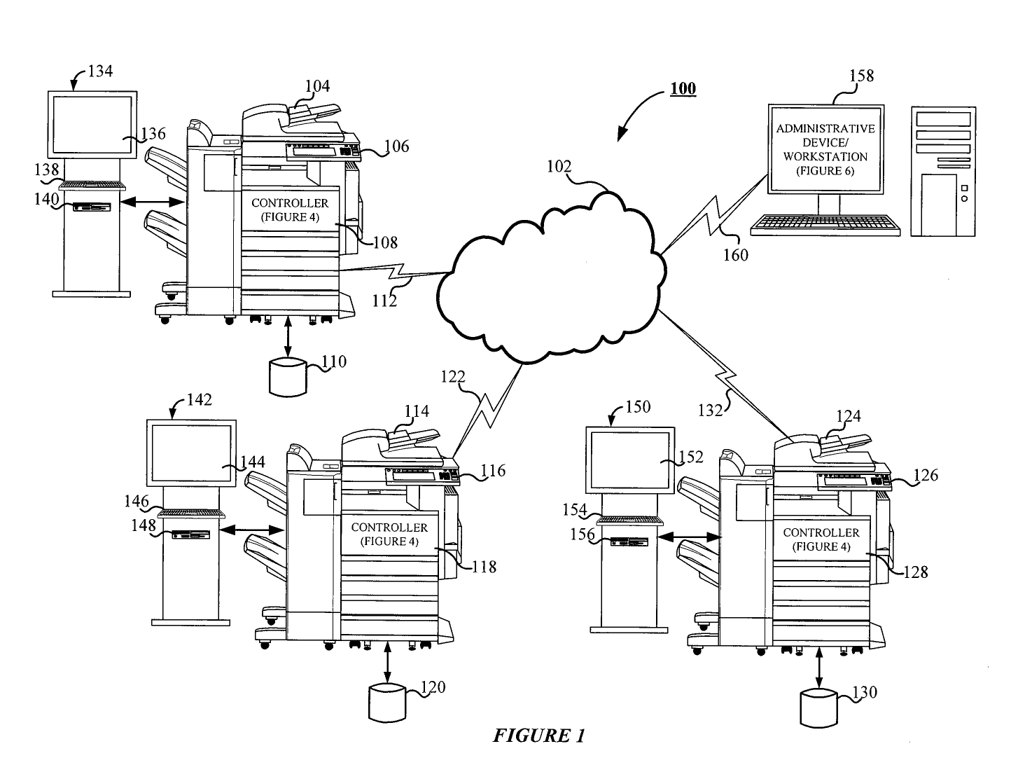

The subject application is directed to a system and method for maintaining security in networked document processing devices. In particular, the subject application is directed to a system and method for maintaining security for networked document processing devices by periodically running test routines on each device and reporting results to an administrator. More particularly, the subject application is directed to a secure state notification system and method for networked devices. It will become apparent to those skilled in the art that the system and method described herein are suitably adapted to a plurality of varying electronic fields employing security monitoring, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a secure state notification system 100 for networked devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, and any suitable combination thereof, configured to interact with an associated user, a networked device, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

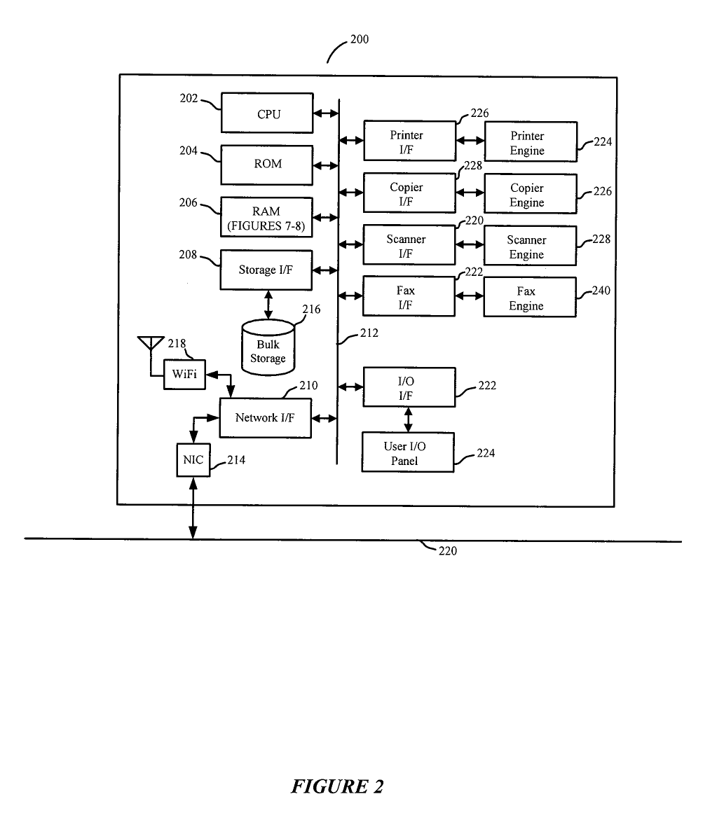

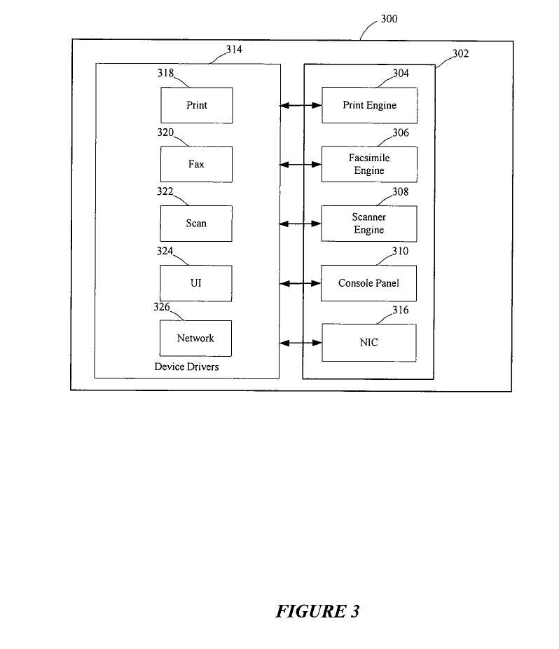

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

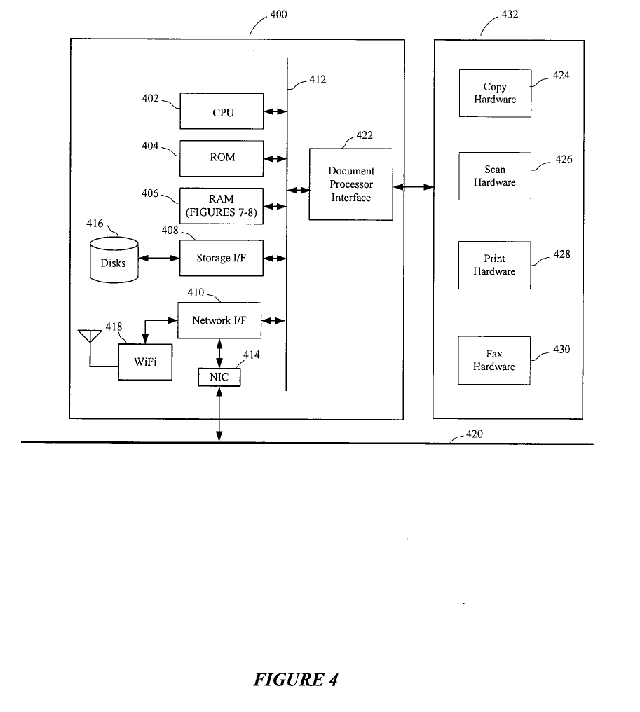

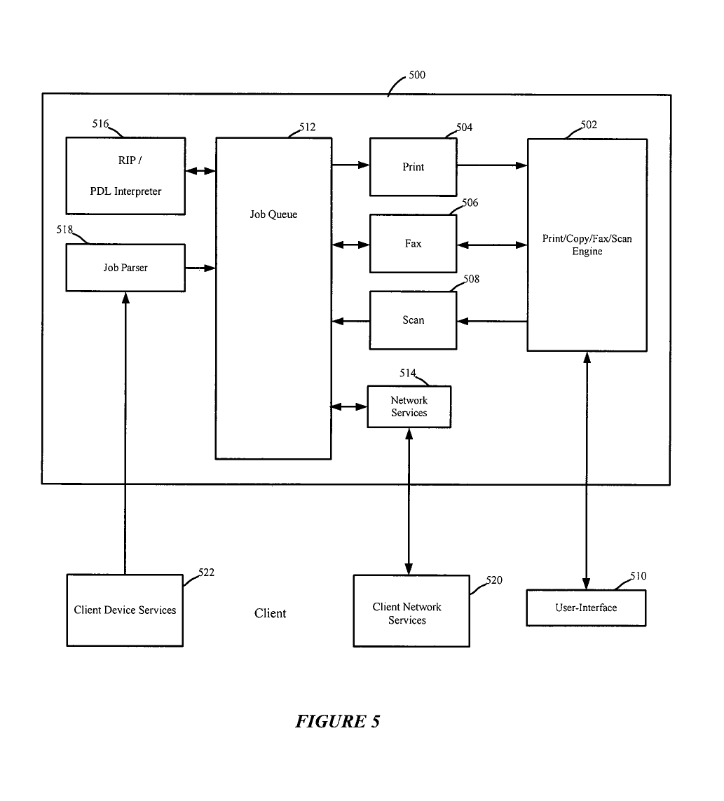

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the secure state notification system and method for networked devices of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

Illustrated in FIG. 1 are a first kiosk 134, communicatively coupled to the first document processing device 104, and in effect, the computer network 102, a second kiosk 142, communicatively coupled to the second document processing device 114, and in effect, the computer network 102, a third kiosk 150 communicatively coupled to the third document processing device 124, and in effect the computer network 102. It will be appreciated by those skilled in the art that the kiosks 134, 142, and 150 are capable of being implemented as separate component of the respective document processing devices 104, 114, and 124, or as integral components thereof. Use of the kiosks 134, 142, and 150 in FIG. 1 are for example purposes only, and the skilled artisan will appreciate that the subject application is capable of implementation without the use of kiosks 134, 142, and 150. In accordance with one embodiment of the subject application, the kiosks 134, 142, and 150 include respective displays 136, 144, and 152 and user input devices 138, 146, and 154. As will be understood by those skilled in the art the kiosks 134, 142, and 150 are capable of implementing a combination user input device/display, such as a touch screen interface. According to one embodiment of the subject application, the kiosks 134, 142, and 150 are suitably adapted to facilitate interactions with users, display selected images, provide prompts to an associated user, receive instructions from the associated user, receive payment data, receive selection data from the associated user, and the like. Preferably, the kiosks 134, 142, and 150 include a magnetic card reader, conventional bar code reader, or the like, suitably adapted to receive and read payment data from a credit card, coupon, debit card, or the like.

The system 100 of FIG. 1 also includes portable storage device readers 140, 148, and 156, coupled to the kiosks 134, 142, and 150 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

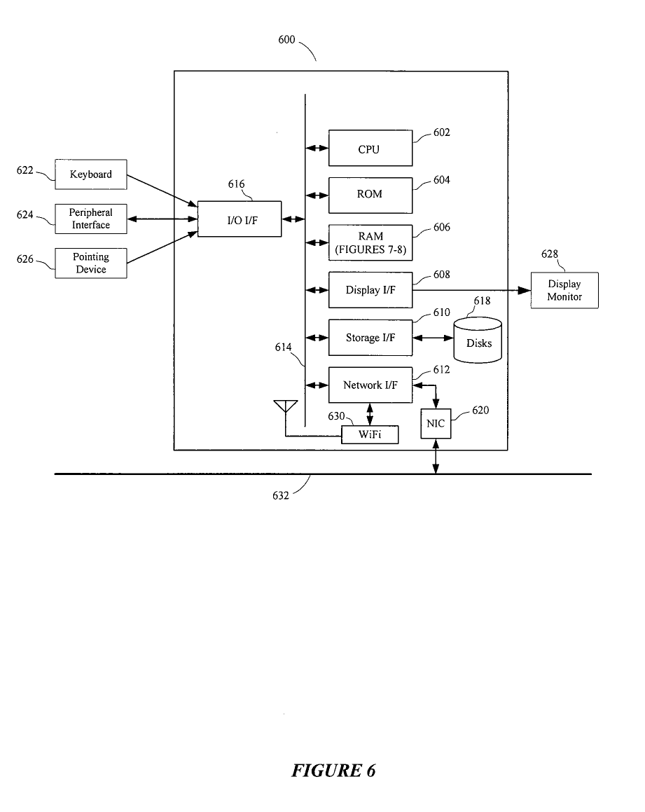

The system 100 illustrated in FIG. 1 further depicts an administrative device 158, in data communication with the computer network 102 via a communications link 160. It will be appreciated by those skilled in the art that the administrative device 158 is shown in FIG. 1 as a computer workstation for illustration purposes only. As will be understood by those skilled in the art, the administrative device 158 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 160 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 160 is suitably adapted to monitor operations of the computer network 102, the document processing devices 104, 114, and 124, or any other similar device coupled to the computer network 102, connect to the Internet, communicate with a backend database, and the like. The functioning of the administrative device 158 will better be understood in conjunction with the block diagram illustrated in FIG. 6, explained in greater detail below.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 322. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the user device 158, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

In operation, security settings associated with networked devices are each self tested by the corresponding networked device. Report data is then generated by each of the networked devices based upon the output of the self testing. A network message is then generated by each of the networked devices via an associated network interface in accordance with the generated report data. A network message is then received from each networked device into an associated administrative device. A display is thereafter generated on the administrative device corresponding to the report data in accordance with each received network message.

In accordance with one example embodiment of the subject application, test configuration data is first communicated to each of the networked devices, e.g. the document processing devices 104, 114, and 124, corresponding to the security settings, operational settings, and the like, that are to be tested. It will be appreciated by those skilled in the art that the configuration data is capable of being communicated to each of the document processing devices 104, 114, and 124 from the administrative device 158 via the computer network 102, from a portable storage device, or the like. Testing schedule data is then communicated to each of the document processing devices 104, 114, and 124 from the administrative device 158 corresponding to a time when each device 104, 114, and 124 is to perform the self testing set forth in the communicated configuration data. According to one embodiment of the subject application, the schedule data is determined by an administrator associated with the administrative device 158 so as to minimize the impact of the testing during document processing operations. It will be appreciated by those skilled in the art that the schedule data is capable of being automatically determined based upon device usage data, such that the schedule data dictates the performance of the self testing during a period of time when the respective document processing devices 104, 114, and 124 are in an inactive state, e.g. no currently pending operations, after normal business hours, weekends, or the like. In accordance with one embodiment of the subject application, the schedule data corresponds to the elapse of a timer associated with each document processing device 104, 114, and 124 such that the output of the timer indicates the performance of self testing by the associated device 104, 114, and 124.

The controllers 108, 118, and 128 or other suitable components associated with the document processing devices 104, 114, and 124 then determines whether an administrative instruction has been received indicating that the document processing device 104, 114, or 124 is to perform an unscheduled self test. That is, the administrative user associated with the administrative device 158 is capable of sending instructions to perform a self test independent of the previously scheduled testing. When such instructions are received from the administrative device 158, the controllers 108, 118, and 128 or other suitable components associated with the document processing devices 104, 114, and 124 analyzes the instructions and completes the self testing in accordance with the received administrative instructions.

When the scheduled time indicated from the schedule data to perform the self testing set forth by the received configuration data occurs, each of the controllers 108, 118, and 128 or other suitable components associated with the document processing devices 104, 114, and 124 performs the self testing. Once any self test has been completed, i.e. either the scheduled test or unscheduled administratively instructed test, the controllers 108, 118, and 128 or other suitable components associated with the document processing devices 104, 114, and 124 determines whether or not the testing has been successfully completed. Any failure to complete the self testing prompts the generation of a failure message for the administrative device 158, which includes data representative of the device 104, 114, or 124, the test, and other suitable data regarding the failure event.

Following the successful completion of a self test, the controllers 108, 118, and 128 or other suitable components associated with the document processing devices 104, 114, and 124 then generates report data corresponding to the results of the self test. A network message that includes the report data is then generated. The generated message, either the failure message or the message generated after successful completion of the self test, is then communicated via the computer network 102 to the administrative device 158.

Upon receipt of the messages from the controllers 108, 118, and 128 or other suitable components associated with the document processing devices 104, 114, and 124, the administrative device 158 generates a suitable display in accordance with the received report data and/or failure data. It will be appreciated by those skilled in the art that such a display enables the administrative user associated with the administrative device 158 to view each self test completed by the document processing devices 104, 114, and 124, and thereupon ascertain the security thereof.

In the event that the administrative user determines that a suspension of operations of one of the document processing devices 104, 114, or 124 is warranted as a result of the self testing, the administrative device 158 generates suspension instructions to the device 104, 114, or 124 warranting suspension. For example, a failed firewall test is capable of requiring the suspension of all operations of a document processing device 104, 114, or 124, whereas a failed cryptographic test suspends only a portion of processing, e.g. confidential print or the like. The administrative device 158 then communicates the suspension instruction to the document processing device 104, 114, or 124 warranting the suspension of some or all document processing operations in view of the self test results. The controller 108, 118, or 128 or other suitable components associated with the document processing device 104, 114, or 124 then suspends a portion of document processing operations associated therewith in accordance with the received suspension instructions. It will be appreciated by those skilled in the art that such a suspension is capable of including, for example and without limitation, the suspension of network-based operations such as electronic mail transmissions, facsimile transmission, or the like, as well as the total suspension of all operations, e.g. suspend printing, copying, facsimile, scanning, and the like.

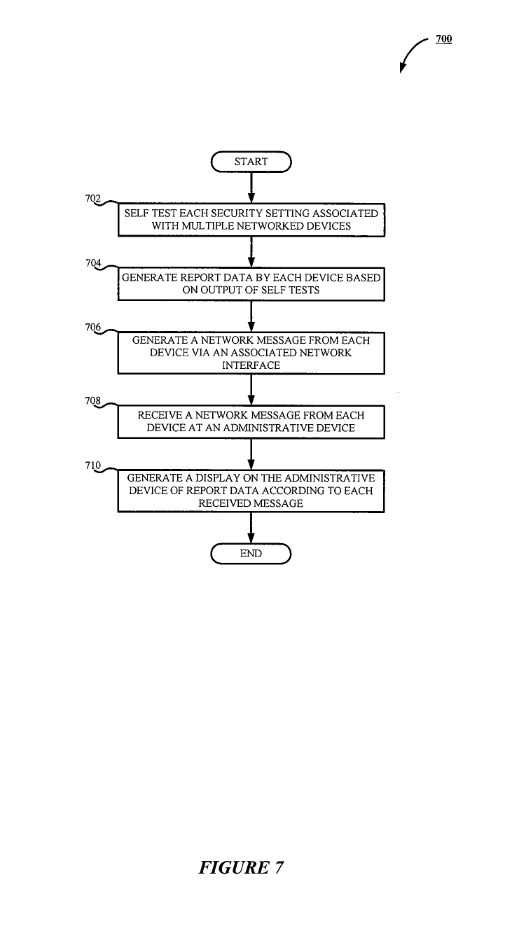

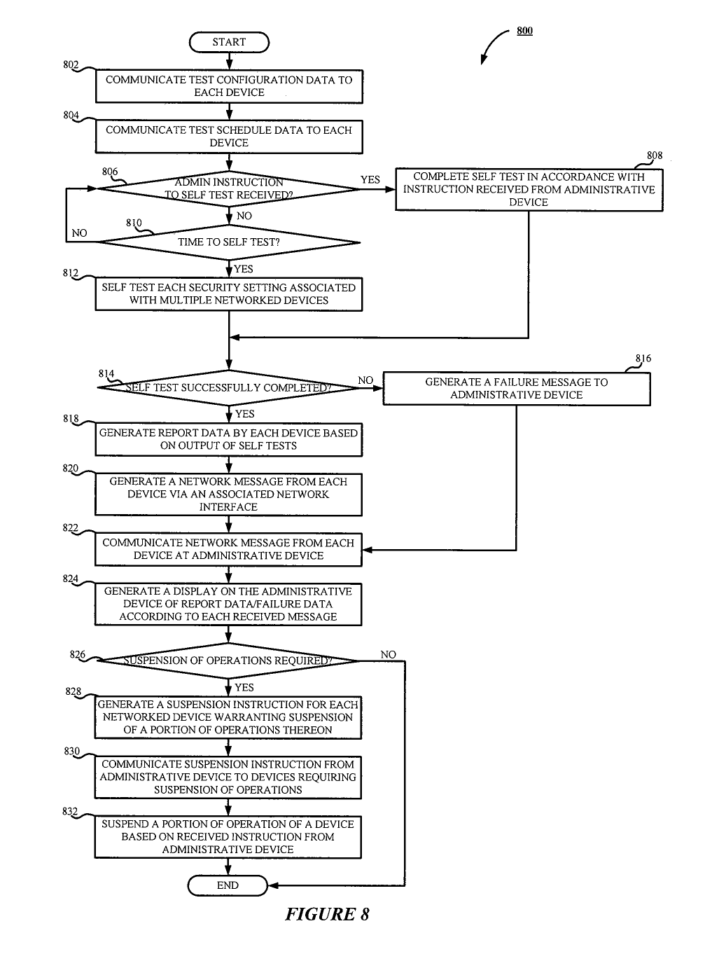

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a secure state notification method for networked devices in accordance with one embodiment of the subject application. Beginning at step 702, each security setting associated each networked device 104, 114, and 124 are self tested. The skilled artisan will appreciate that the use of document processing devices 104, 114, and 124 as the networked devices of FIG. 7 is for example purposes only and the subject application is not limited solely to the self testing of security settings of document processing devices. Preferably, the controller 108, 118, or 128 or other suitable component associated with each respective document processing device 104, 114, or 124 facilitates the self testing of security settings associated therewith. It will be appreciated by those skilled in the art that such security settings include, for example and without limitation, secure erase settings, cryptographic settings, firewall settings, access control settings, and the like. The skilled artisan will appreciate that additional security settings are equally capable of being self tested by each respective document processing device 104, 114, and 124 in accordance with the subject application. In accordance with one embodiment of the subject application, the respective document processing device 104, 114, and 124 performing the self test of security settings temporarily halts document processing operations so as to perform the self test.

At step 704, the controllers 108, 118, and 128 or other suitable component associated with the corresponding document processing device 104, 114, and 124 then each generate report data corresponding to the results of the self test. Each of the document processing devices 104, 114, and 124, via their respective controllers 108, 118, and 128 or other suitable components associated therewith, then generate a network message via an associated network interface corresponding to each document processing device 104, 114, and 124 at step 706.

A network message, inclusive of the report data, is then received by the administrative device 158 at step 708. In accordance with one embodiment of the subject application, the network message is communicated to the administrative device 158 via any suitable communications means known in the art including, for example and without limitation, electronic mail messaging, SMS messaging, or the like. The administrative device 158 then generates a display at step 710 corresponding to the report data in accordance with each received network message. The skilled artisan will therefore appreciate that the administrative user associated with the administrative device 158 is then capable of viewing the various results of the self testing of security settings with respect to each of the networked devices, e.g. the document processing devices 104, 114, and 124.

Referring now to FIG. 8, there is shown a flowchart 800 illustrating a secure state notification method for networked devices in accordance with one embodiment of the subject application. The methodology of FIG. 8 begins at step 802, whereupon test configuration data is communicated to each of the networked devices, e.g. the document processing devices 104, 114, and 124, corresponding to the security settings, operational settings, and the like, that are to be tested. In accordance with one embodiment of the subject application, the configuration data is communicated to each of the document processing devices 104, 114, and 124 from the administrative device 158 via the computer network 102. The skilled artisan will appreciate that other means of providing the test configuration data include, for example and without limitation, a portable storage device, an electronic mail message, or the like.

At step 804, the administrative device 158 communicates test schedule data to each of the networked document processing devices 104, 114, and 124 indicating a time at which each device 104, 114, and 124 is to perform the self testing set forth in the communicated configuration data. According to one embodiment of the subject application, the schedule data is capable of being automatically determined based upon device usage data, such that the schedule data dictates the performance of the self testing during a period of time when the respective document processing devices 104, 114, and 124 are in an inactive state, e.g. no currently pending operations, after normal business hours, weekends, or the like.

A determination is then made at step 806 by the controllers 108, 118, and 128 or other suitable components associated with the document processing devices 104, 114, and 124 whether an administrative instruction has been received from the administrative device 158 indicating that the document processing device 104, 114, or 124 is to perform an unscheduled self test. That is, the administrative user associated with the administrative device 158 is capable of sending instructions to perform a self test independent of the previously scheduled testing. Upon a determination at step 806 that an administrative instruction for self testing has been received, flow proceeds to step 808. At step 808, the controllers 108, 118, or 128 or other suitable components associated with the document processing device 104, 114, or 124 that received the instruction completes the self testing in accordance with the received administrative instructions. Operations then progress to step 814, as discussed in greater detail below.

Upon a determination at step 806 that an administrative instruction has not been received from the administrative device 158, flow proceeds to step 810. At step 810, a determination is made whether the scheduled time indicated from the schedule data has arrived. That is, the controllers 108, 118, and 128 or other suitable component associated with the document processing devices 104, 114, and 124 determines whether the time to perform one or more self tests has occurred. In accordance with one embodiment of the subject application, the schedule data corresponds to the elapse of a timer associated with each document processing device 104, 114, and 124 such that the output of the timer indicates the performance of self testing by the associated device 104, 114, and 124. When the scheduled time to perform the self tests has not arrived, flow returns to step 806 and operations continue therefrom until either an administrative instruction is received, or the scheduled time arrives. Upon a determination at step 810 that the scheduled time has arrived to perform the self testing set forth by the received configuration data, flow proceeds to step 812, whereupon each of the controllers 108, 118, and 128 or other suitable components associated with the document processing devices 104, 114, and 124 performs the self testing.

A determination is then made at step 814 whether the self test has been successfully completed. That is, each controller 108, 118, and 128 or other suitable component associated with the document processing devices 104, 114, and 124 determines whether the self testing associated with that device 104, 114, and 124 has been successfully completed. Upon a determination at step 814 that the self test was not successful, flow proceeds to step 816. At step 816, a failure message is generated by the controller 108, 118, or 128 or other suitable component associated with the document processing device 104, 114, or 124 for which the test was not successfully completed. In accordance with one embodiment of the subject application, the failure message includes, for example and without limitation data representative of the device 104, 114, or 124, the test, and other suitable data regarding the failure event. A network message, inclusive of the failure message, is then communicated to the administrative device 158 at step 822 via the computer network 102.

Returning to step 814, upon a determination that the self test was successfully completed, flow proceeds to step 818. At step 818, report data is generated by each controller 108, 118, and 128 or other suitable component associated with the document processing device 104, 114, and 124 that successfully performed the self test. According to one embodiment of the subject application, the report data includes, for example and without limitation, the results of the self tests, the identification of the device 104, 114, or 124 reporting the self test, and the like. The controller 108, 118, and 128 or other suitable component associated with the document processing device 104, 114, and 124 then generates a network message at step 820 corresponding to the generated report data.

At step 822, the network message is communicated from each networked device 104, 114, and 124 to the administrative device 158 via a suitable network interface over the computer network 102. Upon receipt of the messages from the controllers 108, 118, and 128 or other suitable components associated with the document processing devices 104, 114, and 124, the administrative device 158 generates a suitable display in accordance with the received report data and/or failure data at step 824. It will be appreciated by those skilled in the art that such a display enables the administrative user associated with the administrative device 158 to view each self test completed by the document processing devices 104, 114, and 124, and thereupon ascertain the security thereof.

A determination is then made at step 826 whether a suspension in some or all of the operations of one of the document processing devices 104, 114, or 124 is warranted as a result of the self testing. Upon a negative determination at step 826, operations with respect to the flowchart 800 of FIG. 8 terminate. When it is determined at step 826 that at least one of the networked devices 104, 114, or 124 requires suspension of some or all operations, flow proceeds to step 828. At step 828, the administrative device 158 generates suspension instructions to each of the networked devices 104, 114, or 124 warranting suspension. For example, a failed firewall test is capable of requiring the suspension of all operations of a document processing device 104, 114, or 124, whereas a failed cryptographic test suspends only a portion of processing, e.g. confidential print or the like. At step 830, the administrative device 158 communicates the suspension instruction to the document processing device 104, 114, or 124 warranting the suspension of some or all document processing operations in view of the self test results. The controller 108, 118, or 128 or other suitable components associated with the document processing device 104, 114, or 124 then suspends a portion of document processing operations associated therewith in accordance with the received suspension instructions at step 832. It will be appreciated by those skilled in the art that such a suspension is capable of including, for example and without limitation, the suspension of network-based operations such as electronic mail transmissions, facsimile transmission, or the like, as well as the total suspension of all operations, e.g. suspend printing, copying, facsimile, scanning, and the like.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A secure state notification system for networked devices comprising:
a plurality of networked devices, each networked device including,
a processor,
a data storage,
a network interface,
testing means adapted for self testing each of a plurality of security settings associated therewith,
means adapted for generating report data in accordance with an output of the testing means, and
means adapted for generating a network message in accordance with generated report data via the network interface;
means adapted for receiving a network message from each networked device into an associated administrative device; and
means adapted for generating a display on the associated administrative device corresponding to report data in accordance with each received network message.

2. The system of claim 1 further comprising means adapted for communicating test configuration data to each networked device via its associated network interface, and wherein each testing means includes means adapted for self testing in accordance with received test configuration data.

3. The system of claim 2 wherein each networked device further includes means adapted for suspending at least a portion of operation thereof in accordance with an instruction received from the associated administrative device.

4. The system of claim 2 wherein each testing means further comprises means adapted for determining whether a self test has been successfully completed, and wherein each networked device further comprises means adapted for generating a failure message to the associated administrative device via the network interface in accordance with a determination that a self test has not been successfully completed.

5. The system of claim 1 wherein each networked device includes a timer, and wherein a plurality of self testing operations are completed via each testing means in accordance with an output of the timer.

6. The system of claim 1 wherein each networked device includes means adapted for completing a self testing operation in accordance with an instruction received from the associated administrative device.

7. A secure state notification method for networked devices comprising the steps of:
self testing each of a plurality of security settings associated with each of a plurality of networked devices, wherein each networked device tests each security setting associated therewith;
generating report data, by each of the networked devices, in accordance with an output of the self testing step;
generating a network message, by each of the networked devices via a network interface associated with each networked device, in accordance with generated report data;
receiving a network message from each networked device into an associated administrative device; and
generating a display on the associated administrative device corresponding to report data in accordance with each received network message.

8. The method of claim 7 further comprising the step of communicating test configuration data to each networked device via its associated network interface, and wherein the step of self testing by each networked device is in accordance with received test configuration data.

9. The method of claim 8 further comprising the step of suspending at least a portion of operation of a networked device in accordance with an instruction received from the associated administrative device.

10. The method of claim 8 further comprising the step of determining, by each networked device, whether a self test has been successfully completed and generating a failure message to the associated administrative device, by each networked device by its associated network interface, in accordance with a determination that a self test has not been successfully completed.

11. The method of claim 7 wherein a plurality of self testing operations are completed by each networked device, via the self testing step, in accordance with an output of a timer associated with each networked device.

12. The method of claim 7 further comprising the step of completing a self testing operation, by a networked device, in accordance with an instruction received from the associated administrative device.
